(19) United States
(12) Patent Application Publication
(10) Pub. No.: US 2012/0128349 A1
(43) Pub. Date: May 24, 2012

(54) PASSIVE OPTICAL NETWORK SYSTEM, STATION SIDE APPARATUS AND POWER CONSUMPTION CONTROL METHOD

(75) Inventors: Daiji MITSUNAGA, Yokohama (JP); Hiroki Koyama, Yokohama (JP); Michiaki Moriya, Yokohama (JP); Tomoki Yamashita, Hayama (JP)

(73) Assignee: Hitachi, Ltd.

(21) Appl. No.: 13/296,815

(22) Filed: Nov. 15, 2011

(30) Foreign Application Priority Data
Nov. 19, 2010 (JP) 2010-259454

(51) Int. Cl. H04B 17/00; H04J 14/00; H04L 12/26; H04B 10/08

(52) U.S. Cl. 398/25

(57) ABSTRACT

In a PON system having a station side apparatus (OLT) and plural home side apparatuses (ONUs), the station side apparatus includes an uplink frame transfer processing part controlling frame transfer from the home side apparatus to the station side apparatus, a transfer database managing the destination of frame transfer from the station side apparatus to the plural home side apparatuses, a statistical counter part counting transfer data amount for each user, and a user usage state management part managing the user usage situation. The user usage state management part determines the user usage situation (used/unused) based on the state monitoring result of any one or all of parts described above, switches the operation of the uplink frame transfer control part depending on the usage situation and adjusts DBA control frame amount between the station side apparatus and the home side apparatus.

### CLAIM OF PRIORITY

The present application claims priority from Japanese patent application JP 2010-259454 filed on Nov. 19, 2010, the contents of which are hereby incorporated by reference into this application.

### BACKGROUND OF THE INVENTION

1. Field of the Invention

The present invention relates to a passive optical network system, a station side apparatus and a power consumption control method, and more particularly to a passive optical network system, a station side apparatus and a power consumption control method for realizing the power saving of the station side apparatus and home side apparatuses in the Passive Optical Network (hereinafter referred to as PON) System constituting an optical access network, and especially reducing the power consumption of the system by switching the operation of the PON system based on the result of detecting the unused condition of the user accommodated in the PON.

2. Description of the Related Art

The PON system is an optical access system in which one optical fiber is divided via an optical splitter that is a passive type device to draw into plural subscriber homes. The PON system is generally composed of an Optical Line Terminal (hereinafter referred to as an OLT) equipment installed on the station side of a carrier, an Optical Network Unit (hereinafter referred to as an ONU) that is a home side apparatus installed at the subscriber's home or subscriber building, the optical splitter and the optical fiber. In a section from the OLT within the station to a user living area, one optical fiber is shared among plural subscribers, and the optical fiber is distributed into the subscriber's homes via the optical splitter not requiring power in each user living area. In this way, the PON system is suitable for inexpensively providing an internet connection service or a company oriented private line service to users distributed over a service area, because the equipment can be shared among the plural subscribers by multiplexing plural subscriber signals to make the one-to-multiple connection. Examples of the PON system include a GE-PON system as standardized in an Institute of Electrical and Electronic Engineers (IEEE) 802.3ah, and a 10G-EPON system as standardized in the IEEE802.3av. In recent years, there has been a growing interest worldwide in the environmental problems, whereby the energy saving measures are an essential subject for companies and homes, and in the field of communication apparatus, a power saving function and a function of reducing a load on the apparatus when not in use have been examined.

As the background technology in this technical field, there is JP-A-2008-113193 (patent document 1). This official gazette describes that “a subscriber side apparatus for suppressing the power consumption efficiently can be obtained by monitoring the connection state of the ONU with the OLT or Terminal Equipment (TE) and setting the functional block of the ONU in a low power consumption mode”. Also, there is JP-A-2006-115143 (patent document 2). This official gazette describes that “since the logical link is established for each application as needed, it is unnecessary to waste the processing power of each optical terminating device on the center side and user side to maintain the logical link not in use”.

### SUMMARY OF THE INVENTION

In the above method of patent document 1, there is a problem that since the ONU transits to a low power consumption mode only when a User Network Interface (UNI) link state of the ONU or the optical link state on the PON side is down, the power consumption can not be reduced at all in a state where the UNI link or optical link is up. Also, the power consumption reduction object is only the ONUs in the PON system. Also, when the hardware is placed in the low power consumption mode, a restoration processing time for resuming the communication operation of user frame after releasing the mode is required, but no consideration is taken for the continuity of service in this point.

In an example of patent document 2, the logical link itself between OLT and ONU is disconnected in detecting a unused state for the user application. With this method, in transiting from the unused state to the use state, an initiation determination process of the application and a Discovery sequence process for establishing the logical link with the OLT again and registering the ONU take a lot of time. Accordingly, there is a problem that the communication cannot be started in an instant.

In the light of the above-mentioned problems, it is an object of the invention to provide a passive optical network system, a station side apparatus and a power consumption control method capable of reducing the operation frequency of electronic circuits and optical devices in both the OLT and the ONT in an unused state by a user and reducing the power consumption while maintaining the continuity of service. Also, it is another object of the invention to provide user usage state management means for determining the use situation of the user accommodated in the PON system in the station side apparatus, and suppress a transmitting and receiving process for unnecessary control frames at the time of making the user unused determination in the state where the logical link between OLT and ONU is maintained.

A PON system according to this invention has a station side apparatus (OLT) and plural home side apparatuses (ONUs), which are connected via an optical fiber network having an optical splitter, in which the station side apparatus includes a Dynamic Bandwidth Allocation (DBA) processing part for controlling the frame transfer in the direction from ONU to OLT, a transfer database part for managing the destination of user frame transfer from OLT to the plural ONUs, a statistical counter part for counting the transfer data amount of each user, and a user usage state management part for managing the user use situation.

The user usage state management part determines the user usage situation based on the state monitoring result of one or all of the DBA processing part, the transfer database part and the statistical counter part, switches the operation of the DBA control part depending on the use situation and adjusts the control frame amount between OLT and GNU.

In this invention, by determining that the user is in the unused state depending on the presence or absence of user traffic, and reducing the DBA control frame amount for use in the user frame transfer between ONU and OLT when not in use, it is possible to reduce the operation frequency of the electronic circuits and the optical devices for both of the OLT and ONU and the power consumption even in a state where the user can use the network, such as when various kinds of terminal is being connected to the ONU and the power of the terminal is on.

According to the first solving means of this invention, there is provided a passive optical network system comprising a station side apparatus and a plurality of home side apparatuses, in which the station side apparatus allocates uplink bandwidth to each of home side apparatuses by transmitting and receiving a control packets via logical links between the station side apparatus and each of home side apparatuses and provides allocated uplink bandwidth to the home side apparatuses, wherein

the station side apparatus comprises:

a transfer database for storing transfer information for specifying a destination of frame transfer from the station side apparatus to the plurality of home side apparatuses for each logical link;

a transfer processing part for performing a transfer process of a frame;

a statistical counter for counting a transfer data amount for each logical link; and

a usage state management part for determining a logical link for which the transfer information is not registered in the transfer database and/or a logical link for which a count value of the statistical counter is not increased within a predetermined time as unused link, and decreasing a control packet amount per unit time to the logical link that is determined as the unused link.

According to the second solving means of this invention, there is provided a passive optical network system comprising a station side apparatus and a plurality of home side apparatuses, in which the station side apparatus allocates uplink bandwidth to each of home side apparatuses by transmitting and receiving a control packets via logical links between the station side apparatus and each of home side apparatuses and provides allocated uplink bandwidth to the home side apparatuses, wherein

at least one of the home side apparatuses comprises:

a transfer database for storing transfer information for specifying a destination of frame transfer from the home side apparatus to a user terminal for each logical link;

a transfer processing part for performing a transfer process of a frame; and

a statistical counter for counting a transfer data amount for each logical link, and

the station side apparatus comprises:

a monitor control processing part for acquiring the transfer information of the transfer database and a count value of the statistical counter in the home side apparatus; and

a usage state management part for determining a logical link for which the transfer information is not registered in the transfer database and/or a logical link for which the count value of the statistical counter is not increased within a predetermined time as unused link, and decreasing a control packet amount per unit time to the logical link that is determined as the unused link.

According to the third solving means of this invention, there is provided a station side apparatus in a passive optical network system which includes the station side apparatus and a plurality of home side apparatuses, in which the station side apparatus allocates uplink bandwidth to each of home side apparatuses by transmitting and receiving a control packets via logical links between the station side apparatus and each of home side apparatuses and provides allocated uplink bandwidth to the home side apparatuses, the station side apparatus comprising:

a transfer database for storing transfer information for specifying a destination of frame transfer from the station side apparatus to the plurality of home side apparatuses for each logical link;

a transfer processing part for performing a transfer process of a frame;

a statistical counter for counting a transfer data amount for each logical link; and

a usage state management part for determining a logical link for which the transfer information is not registered in the transfer database and/or a logical link for which a count value of the statistical counter is not increased within a predetermined time as unused link, and decreasing a control packet amount per unit time to the logical link that is determined as the unused link.

According to the fourth solving means of this invention, there is provided a power consumption control method for use in a passive optical network system which includes a station side apparatus and a plurality of home side apparatuses, in which the station side apparatus allocates uplink bandwidth to each of home side apparatuses by transmitting and receiving a control packets via logical links between the station side apparatus and each of home side apparatuses and provides allocated uplink bandwidth to the home side apparatuses,

the method comprising steps of:

registering or deleting transfer information for specifying a destination of frame transfer from the station side apparatus to the plurality of home side apparatuses for each logical link in or from a transfer database by a process of a predetermined protocol in accordance with a transfer mode of the logical link;

counting a transfer data amount for each logical link; and

determining a logical link for which the transfer information is not registered in the transfer database and/or a logical link for which a count value of the statistical counter is not increased within a predetermined time as unused link, and decreasing a control packet amount per unit time to the logical link that is determined as the unused link.

According to the invention, it is possible to provide a passive optical network system, a station side apparatus and a power consumption control method capable of reducing the operation frequency of electronic circuits and optical devices in both the OLT and the ONT in an unused state by a user and reducing the power consumption while maintaining the continuity of service. Also, according to the invention, it is possible to provide user usage state management means for determining the use situation of the user accommodated in the PON system in the station side apparatus, and suppress a transmitting and receiving process for unnecessary control frames at the time of making the user unused determination in the state where the logical link between OLT and ONU is maintained.

### BRIEF DESCRIPTION OF THE INVENTION

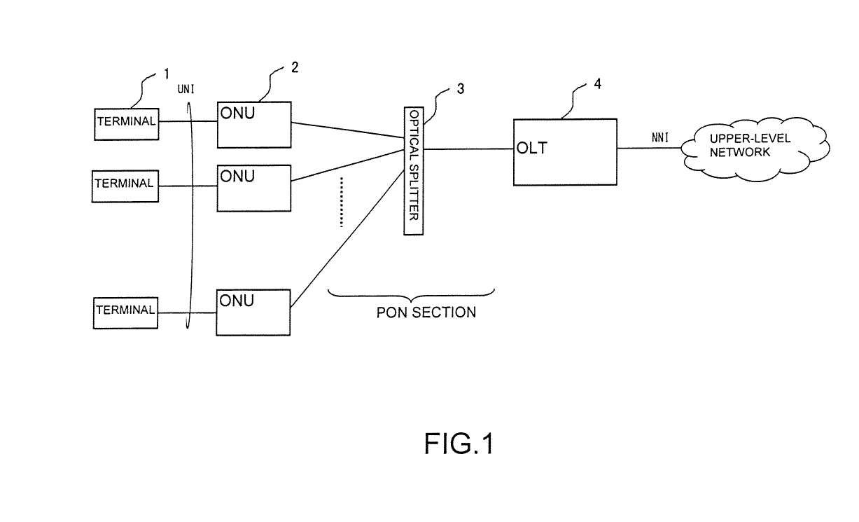

FIG. 1 is a schematic diagram showing a configuration example of a PON system.

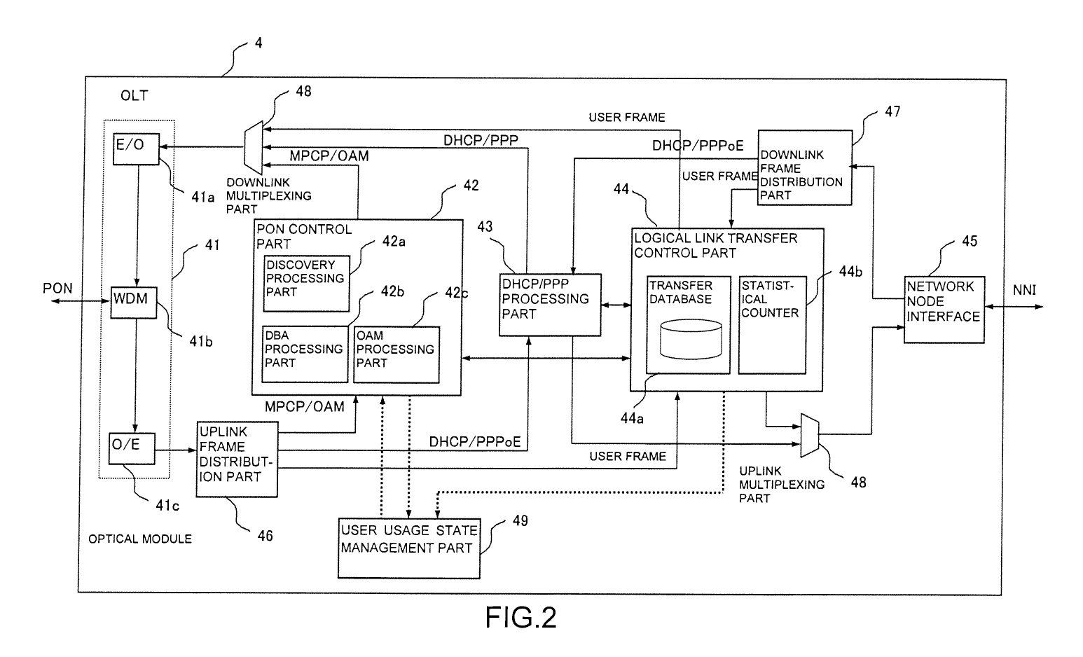

FIG. 2 is a block diagram of an OLT.

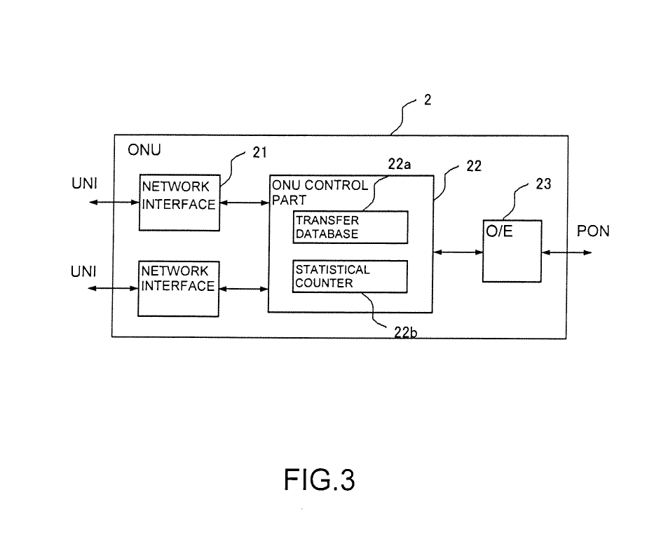

FIG. 3 is a block diagram of an ONU.

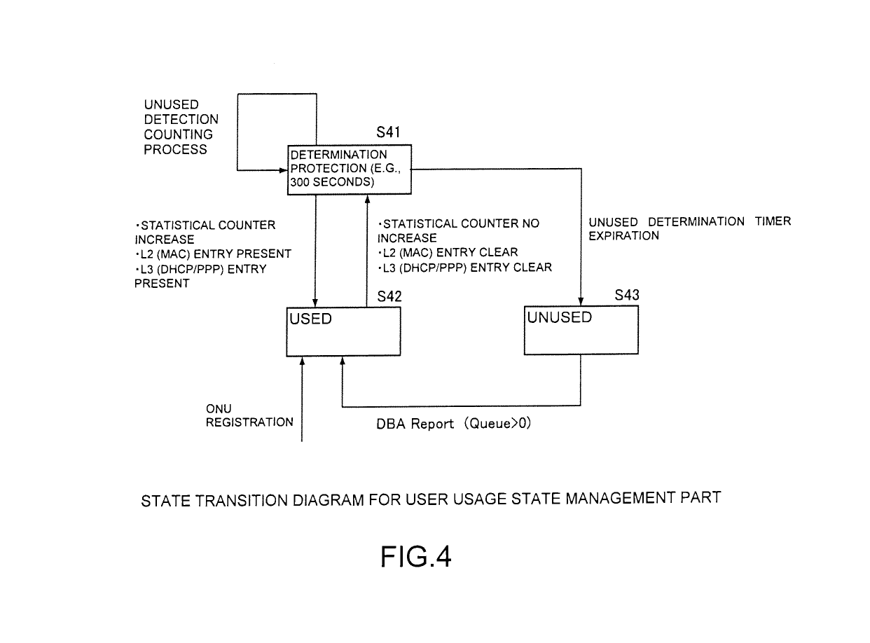

FIG. 4 is a state transition diagram of a user usage state management part.

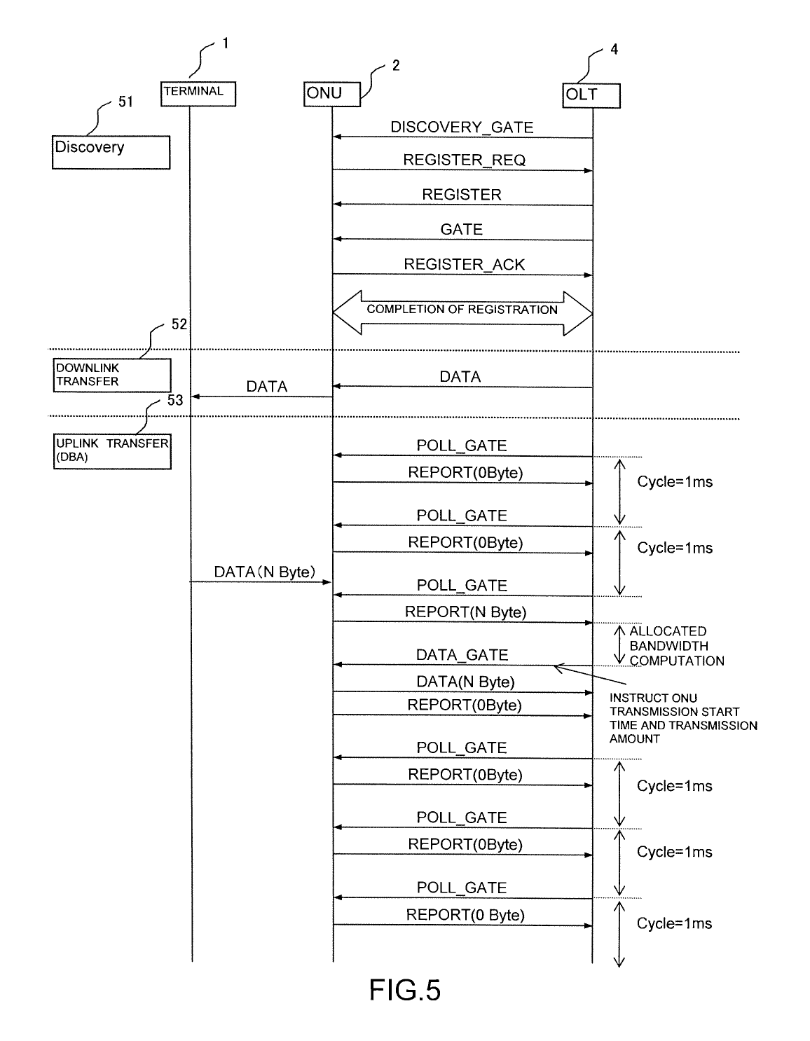

FIG. 5 is an explanatory view showing an ONU registration and a frame transfer sequence of the PON.

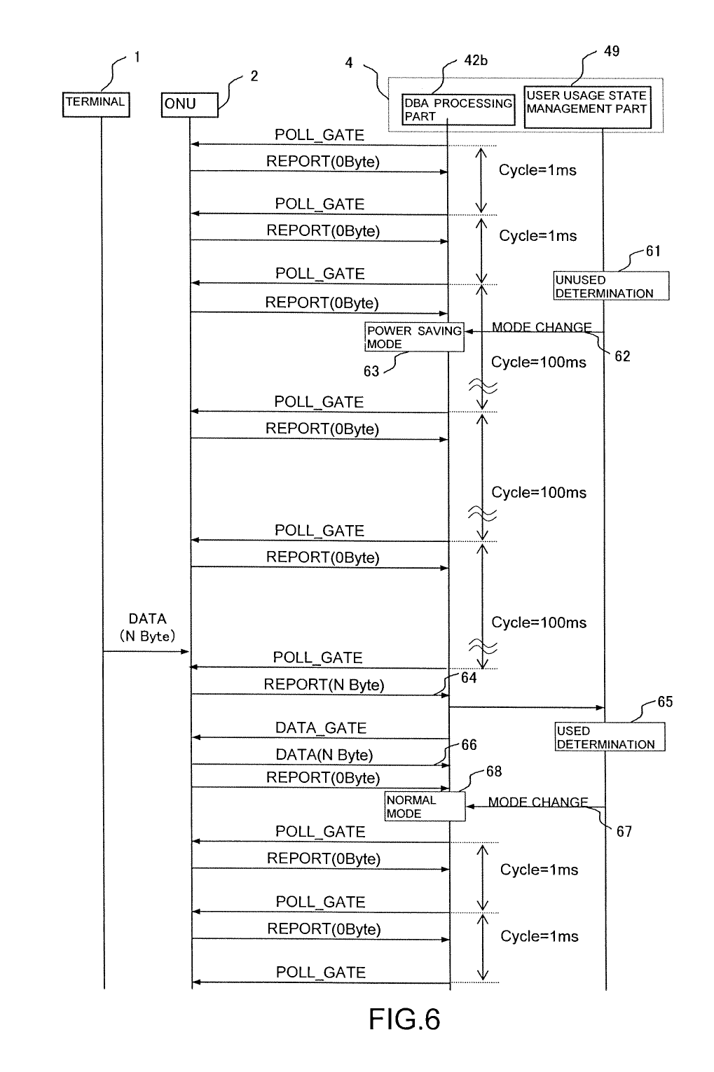

FIG. 6 is a view showing an uplink transfer sequence of the PON system according to the invention.

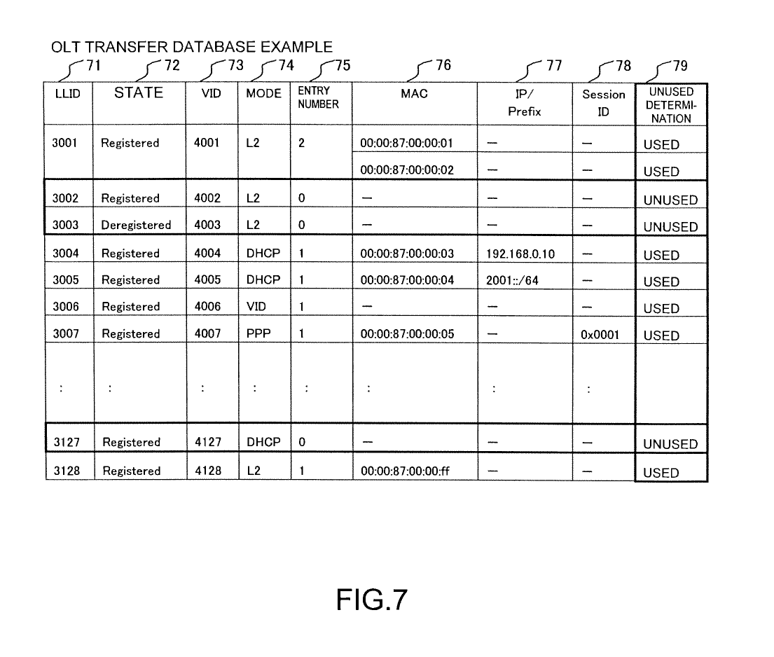

FIG. 7 is an explanatory view of a transfer database of the OLT.

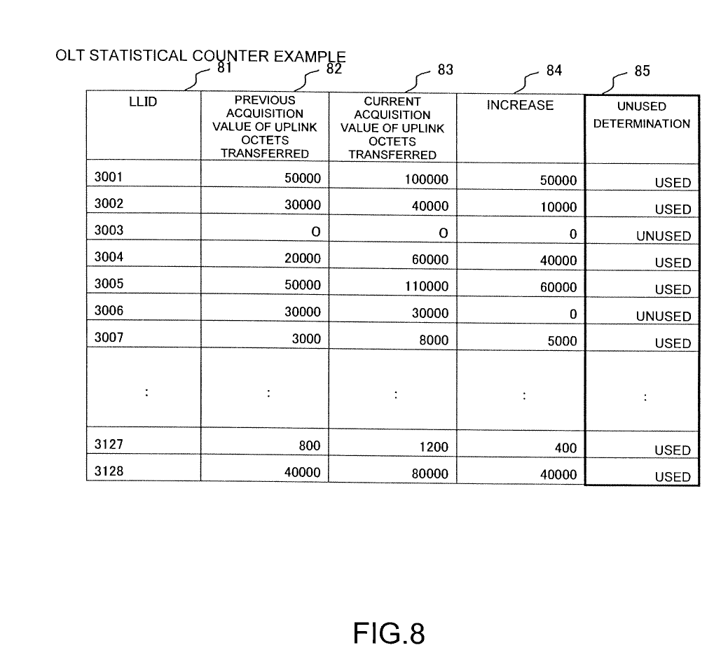

FIG. 8 is an explanatory view of a statistical counter of the OLT.

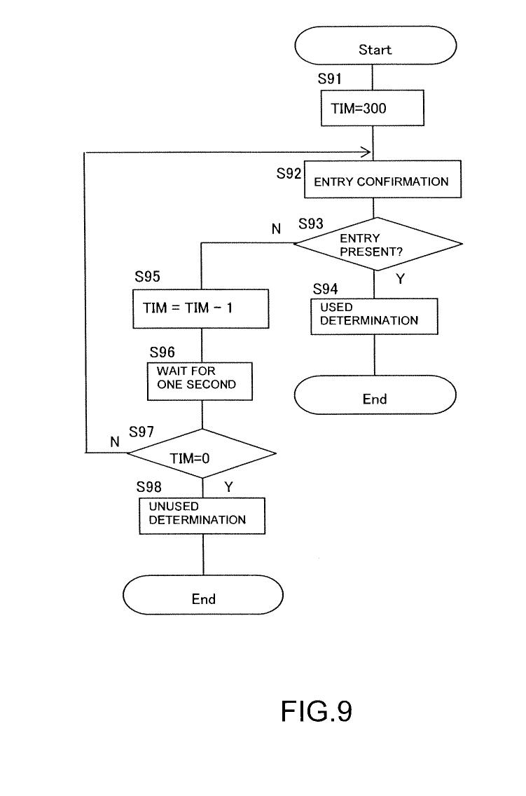

FIG. 9 is an L2/L3 entry determination protection flowchart in a user unused state management part.

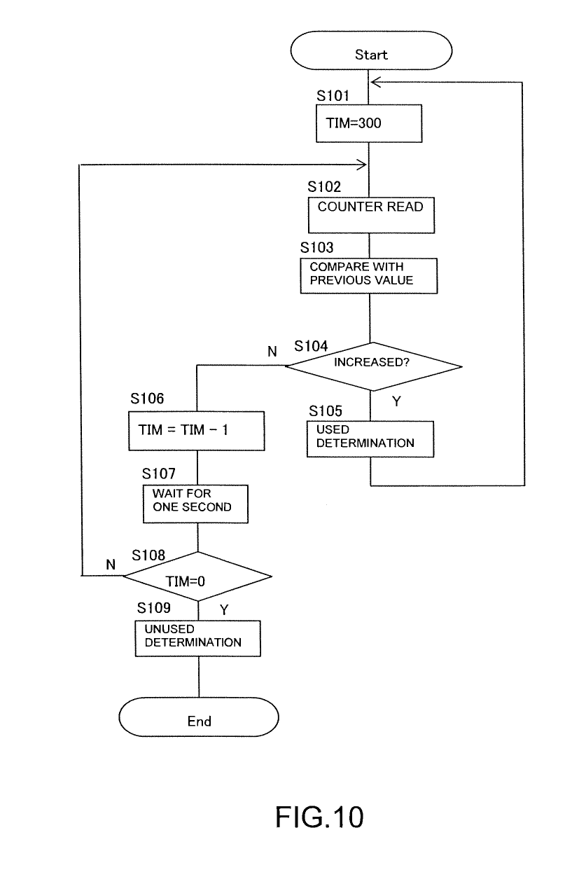

FIG. 10 is a statistical counter determination protection flowchart in the user unused state management part.

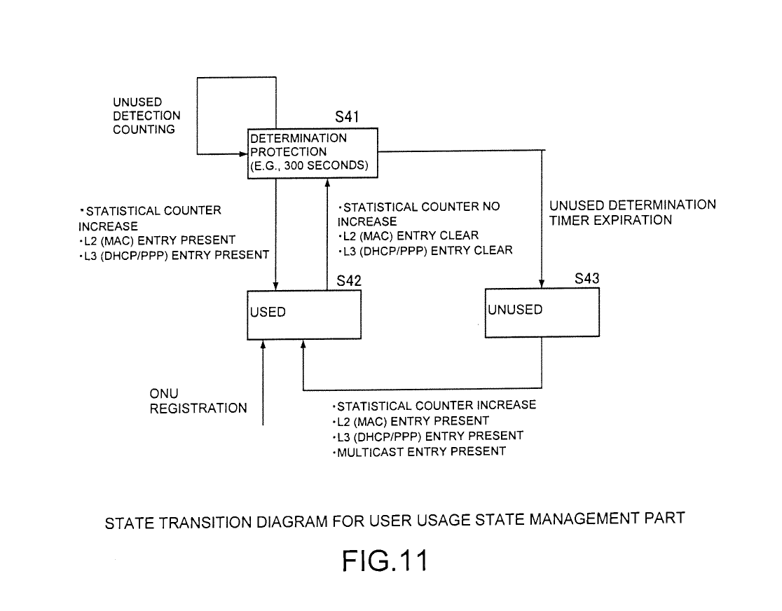

FIG. 11 is a state transition diagram of the user unused state management part according to a third embodiment of the invention.

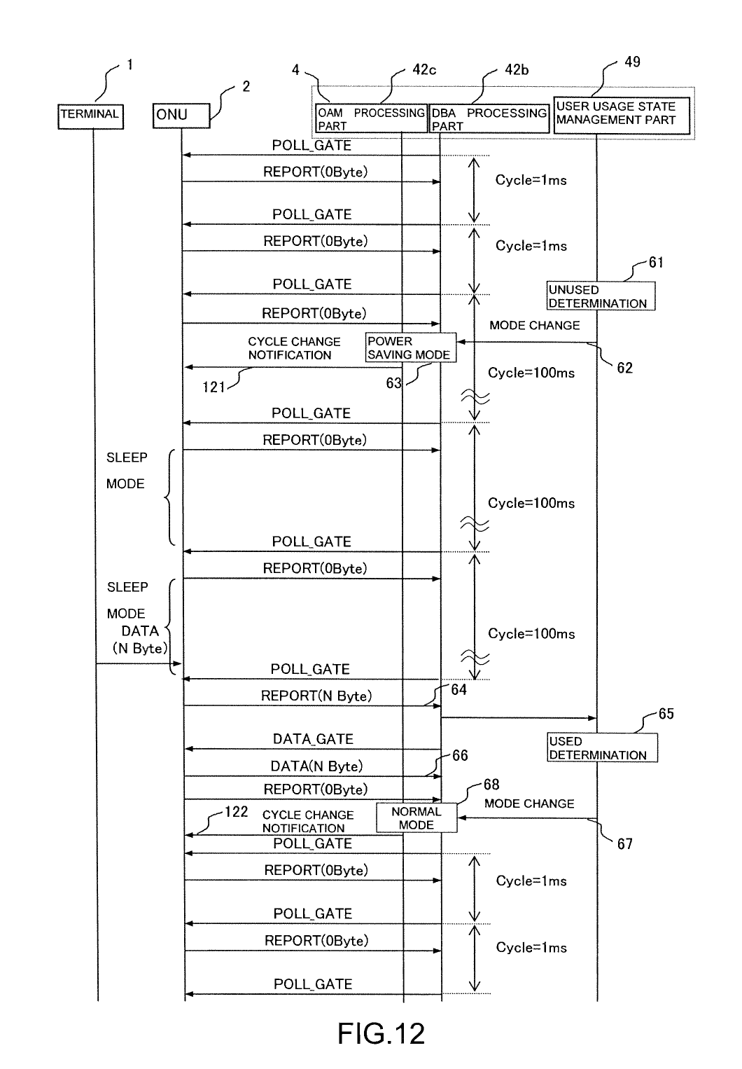

FIG. 12 shows an uplink transfer sequence of the PON system according to a forth embodiment of the invention.

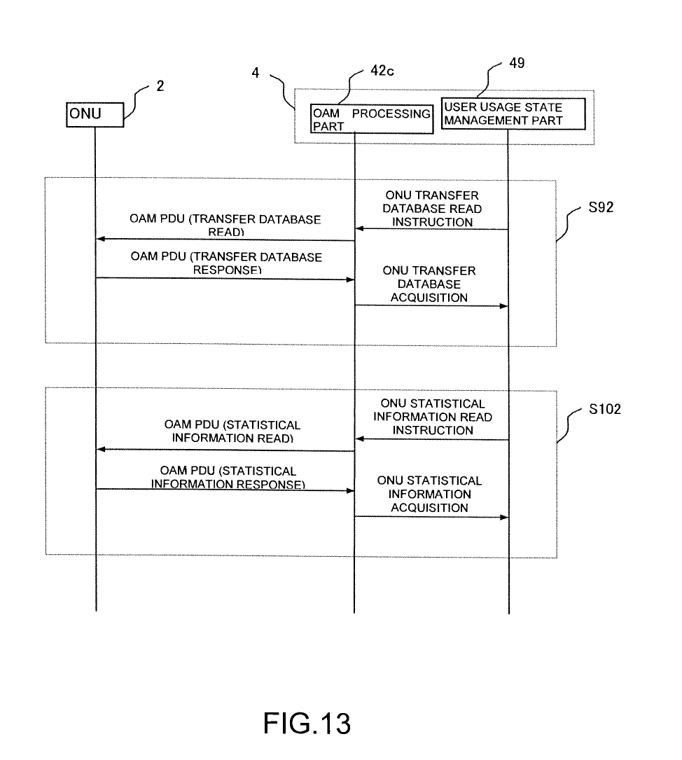

FIG. 13 is a diagram showing an ONU information acquisition sequence according to a second embodiment of the invention.

### DETAILED DESCRIPTION OF PREFERRED EMBODIMENTS

The embodiments of the present invention will be described below with reference to the drawings.

### First Embodiment

FIG. 1 is a schematic diagram showing a configuration example of a PON system.

The PON system has an OLT 4 that is a station side apparatus installed in a station house of a carrier, for example, and plural ONUs 2 installed in subscriber's homes, for example, which are connected via an optical fiber and an optical splitter 3. The ONU 2 has a UNI interface, to which a terminal or communication apparatus such as a personal computer, a router or a terminal adaptor within the user home is connected. In FIG. 1, terminals 1 are shown. On the upper-level side of the OLT 4, there is a Network Node Interface (NNI), in which the PON system is connected through this interface via a core network of the carrier to an upper-level network such as internet. As shown in FIG. 1, the OLT 4 and the ONUs 2 are connected at 1 to N in the PON system. Between the OLT 4 and the ONUs 2, plural logical links are set on one physical link, and a path to each ONU 2 is set by this logical link. In the case of a GE-PON, an identifier called a Logical Link ID, logical link identifier (LLID) is embedded in a preamble part of Ethernet frame, whereby data multiplexing of ONUs is realized with this identifier. For a downlink signal of the PON (in the direction from the upper-level network to the user home), the same signal arrives at all of the ONUs 2, and each ONU 2 judges whether or not the received frame is addressed to its own based on the LLID, and chooses the received frame. On the other hand, if the plural ONUs 2 transmit an uplink signal at the same time, a data collision may occur, whereby the frame transfer is realized under the polling control from the OLT 4. In the PON, one optical fiber is shared among the plural ONUs 2, in which a control of dynamically allocating an uplink bandwidth from the ONU 2 to the OLT 4 depending on the traffic volume is performed under the polling control, and called a DBA control.

FIG. 2 is a block diagram of the OLT according to this embodiment.

The OLT 4 has an optical module 41, a PON control part 42, a DHCP/PPP processing part 43, a logical link transfer control part 44, a network node interface 45, an uplink frame distribution part 46, a downlink frame distribution part 47, an uplink multiplexing part 48, and a user usage state management part 49, for example.

The optical module 41 is a functional block of making the optical/electrical conversion, in which the optical signals of the PON are multiplexed or de-multiplexed with the uplink or downlink wavelength by a WDM 41b. In the case of a GE-PON of IEEE802.3ah, the uplink wavelength of 1.31 μm and the downlink wavelength of 1.49 μm are used. The uplink signal is converted from optical to electrical form by an O/E conversion part 41c, and the downlink signal is converted from optical to electrical form by an O/E conversion part 41a.

The PON control part 42 is a functional block for making the control with the ONUs 2 on the PON interface. A Discovery processing part 42a deals with a registration sequence in adding the new ONU 2 onto the PON. A DBA processing part 42b performs a polling control for transferring the uplink signal from the ONU 2 to the OLT 4 and an uplink bandwidth control on each logical link. In these Discovery process and DBA process, a protocol called a Multi Point Control Protocol (MPCP) is used. An Operation, Administration, and Maintenance (OAM) processing part 42c is a part for monitoring and controlling the ONUs 2, to make various kinds of settings on the ONU device, read the state, or make the fault notification using the OAM frame.

The logical link transfer control part 44 controls the frame transfer in the down direction of each logical link. The transfer database 44a has a transfer table for each logical link, in which the downlink frame is collated with this transfer table to decide the logical link for transfer. A statistical counter 44b adds up the number of uplink/downlink frames or the number of bytes transferred on each logical link.

The DHCP/PPP processing part 43 is a functional block for using the address of the layer 3 or equivalent in the transfer on the logical link. In the DHCP, the IP address is delivered to the terminal through a sequence like Discover-Offer-Request-Ack between the user terminal and the DHCP server, as defined in an Internet Engineering Task Force (IETF) RFC 2131. The DHCP/PPP processing part 43 snoops into this sequence, confirms the address extraction result, and registers the result of binding the L2 address (MAC) and the L3 address (IP) in the transfer database 44a. In this case, the downlink frame transfer is determined by a combination of the MAC address and the IP address. Likewise, it snoops into a disconnection sequence, and clears the concerned entry from the transfer database 44a if the address is released (freed). Also, it manages the address lease time extracted from the DHCP server, and clears the entry if the timer expires (Expires). For the DHCPv6 as defined in the RFC3315, the binding entry of the L2 address (MAC) and the L3 address (IPv6) is added to/deleted from the transfer database 44a based on the snoop result. For the PPPoE as defined in the RFC2516, the binding entry is similarly added or deleted, using the PPPoE session ID instead of the L3 address. The operation of the user usage state management part 49 will be described later in detail.

Next, a basic stream of data in the OLT 4 will be described below. An uplink frame received from the ONU 2 is converted into an electrical signal in the O/E conversion part 41c of the optical module 41, and inputted into the uplink frame distribution part 46. In the uplink frame distribution part 46, the frame format is analyzed, and the MPCP/OAM frame is distributed to the PON control part 42 and terminated. The DHCP/PPP frame is inputted into the DHCP/PPP processing part 43 for the snoop processing, multiplexed again with the user frame in the uplink multiplexing part 48, and inputted into the network node interface 45. The user frame is inputted into the logical link transfer control part 44. In the case where the mode of the logical link is the L2 mode, the source MAC address of the frame is registered in the transfer database 44a, and inputted into the network node interface 45. In the network node interface 45, the physical interface conversion is performed according to the NNI interface class.

The downlink data inputted from the NNI is inputted via the network node interface 45 into the downlink frame distribution part 47, where the frame format is analyzed. The user frame is inputted into the logical link transfer control part 44, and collated with the transfer database 44a to decide the logical link of transfer target. The concerned LLID is given to the frame, and outputted to the downlink multiplexing part 48. The DHCP/PPPoE frame is inputted into the DHCP/PPP processing part 43 for the snoop processing, and outputted to the downlink multiplexing part 48. These frames and the MPCP/OAM frame generated in the PON control part 42 are finally multiplexed in the downlink multiplexing part 48, converted into optical form in the optical module 41 and outputted to the PON section.

FIG. 3 is a block diagram of the ONU according to this embodiment.

The ONU 2 has an optical module 23 for making the O/E conversion of the PON interface, an ONU control part 22 for making the frame transfer control of the ONU, and a network interface 21 for connection of the user terminal. The ONU control part 22 has a transfer database 22a and a statistical counter 22b for every network interface.

Next, the operation will be described below by comparing the switching between the normal mode and the power saving mode of this embodiment using a control sequence between OLT and ONU.

FIG. 5 shows an ONU registration in the PON and the subsequent downlink and uplink frame transfer control sequence. This chart is an example of using one ONU and one LLID, and if there are plural ONUS, these plural sequences are performed in parallel.

An ONU registration process 51 is called a Discovery, to which DISCOVERY_GATE is periodically sent from the OLT 4. If the ONU 2 is connected to the PON, it responds to this DISCOVERRY-GATE and sends REGISTER_REQ. The OLT 4 computes the distance to the ONU based on the response result from the ONU 2, and gives notice of the LLID with REGISTER. Thereafter, the OLT sends GATE describing the reply timing information from the ONU, and the ONU sends REGISTER ACK at the timing described in the GATE, completing the registration.

For a downlink data transfer 52 after registration, data is optically broadcast from the OLT 4 to the ONU 2, and the ONU 2 captures the data and outputs it to the terminal if the data is addressed to its own.

In an uplink data transfer (DBA) 53, POLL_GATE is periodically sent from the OLT 4 to the ONU 2. In an example of FIG. 5, the sending cycle is 1 ms. The ONU 2 responds with REPORT to POLL_GATE and notifies to the OLT 4 of the data amount (Queue length) accumulated in the ONU 2 with the REPORT. If there is no uplink data, it responds with Queue length 0 Byte, and this operation is repeated. If the NByte data in the uplink direction is inputted from the terminal 1 into the ONU 2, the ONU 2 gives notice of the data amount with the next REPORT. The OLT 4 computes the bandwidth that can be allocated to the concerned ONU 2, and instructs the ONU send start time and the sending volume with DATA_GATE. The ONU 2 sends the uplink data in accordance with the instruction of the OLT 4, and further sends the REPORT. If the data still remains on the ONU 2, it is possible to give again notice of the Queue length with this REPORT. After the end of uplink data transfer, the periodical polling process is repeated with the POLL_GATE again.

The operation of this embodiment is shown in FIG. 6. FIG. 6 shows the DBA control in the uplink direction.

The DBA processing part 42b of the OLT 4 performs a POLL_GATE sending process at the normal sending cycle (e.g., 1 ms). The user usage state management part 49 makes a used/unused determination 61 for determining whether the LLID is used or not. If the LLID is determined to be unused, the user usage state management part 49 instructs the DBA processing part 42b to make a mode change 62. The used/unused determination will be described later in detail. The DBA processing part 42b changes a process for this LLID to a power saving mode 63 to expand the sending cycle of POLL_GATE. In an example of FIG. 6, the cycle is expanded 100 times, from 1 ms to 100 ms. Accordingly, in the power saving mode, the DBA control traffic between OLT and ONU is reduced to 1/100. The sending cycle may be changed to a predetermined time or multiple, besides 100 ms, or 100 times. Also, it can be adjusted in multiple stages. If the ONU 2 receives the uplink data from the terminal 1, the ONU 2 gives notice of the data amount with the next REPORT 64, and the DBA processing part 42b notifies the user usage state management part 49 of the information which shows uplink data is present. The user usage state management part 49, upon receiving the notification, updates the internal management state for the concerned LLID to be used 65, and makes an instruction of switching 67 to the normal mode to the DBA control part 42b. The DBA control part 42b, upon receiving this instruction, switches the mode to the normal mode 68, and restores the polling cycle from 100 ms to 1 ms.

Next, the configuration of the transfer database 44a referred by the user usage state management part 49 and the used/unused determination with the transfer database 44a will be described below using FIG. 7. On the physical interface of the PON, plural logical interfaces can be configured to transmit the data multiplexed. The logical interface is identified by the LLID. Each LLID can be set in a different transfer mode in accordance with the provided service. The OLT manages the state of all LLIDs in a database format of FIG. 7, the frame inputted into the OLT is collated with this database, and transferred to the link of which the LLID is matched with certain condition.

FIG. 7 is an example of the transfer database of the OLT in the case where the number of LLIDs is 128. The transfer database includes the LLID 71, state information 72, VID 73, MODE 74, the number of 75, MAC address 76, IP address/Prefix information 77, Session ID 78, and unused link determination information 79, for example.

In this example, there are 128 LLIDs 71 from 3001 to 3128. For the state information 72, the “Registered” means that it is already registered and the “Deregistered” means that it is unconnected. For example, “Registered” is stored if the ONU is connected and the Discovery process of FIG. 5 is completed, whereas the “Deregistered” is stored if this process is not completed. The VID 73 indicates the VLAN ID at a point of NNI for the frame transferred on each LLID. The MODE 74 is a downlink transfer mode of each LLID. The L2 means the transfer with learned MAC address, DHCP means the transfer with a combination of learned MAC and IP or IPv6 Prefix, VID means the transfer with VLAN ID only, and PPP means the transfer with a combination of MAC address and PPPoE session ID.

In the L2 mode, the MAC learning is performed by registering the source MAC address 76 of the uplink frame in this database, and if there is no communication for a certain time, the MAC address 76 is erased from the database through an aging process. Also, the number of entry 75 is incremented by registering the address. The number of entry 75 is decremented by deleting the address. The update of the number of entry 75 is made in the same way in other modes. In FIG. 7, there is described an example in which the LLIDs 3001, 3002, 3003 and 3128 operate in the L2 mode. Here, for the LLIDs 3001 and 3128, there are entries of the MAC address 76, whereby the frame having the MAC address matched with these entries is transferred from the OLT to the ONU. The LLIDs 3001 and 3128 which the MODEs 74 correspond to is L2 are judged to be used because the MAC address 76 corresponding thereto is registered and the entry is present (the number of entry 75 is 1 or greater), whereas the LLIDs 3002 and 3003 are judged to be unused because the number of entry is 0. The transfer database can have plural entries for one LLID, the entries being composed of the MAC address 76, IP address/Prefix information 77 and Session ID 78 as shown in FIG. 7.

In the DHCP mode, the MAC address 76 and the allocated L3 address information (IP/Prefix 77) are registered as the entry in the database, based on the snoop result in the DHCP or DHCPv6 connection sequence. These addresses are erased based on the snoop result of the disconnection sequence and a DHCP lease timer. In FIG. 7, there is described an example in which the LLIDs 3004, 3005 and 3127 operate in the DHCP mode. Herein, the LLIDs 3004 and 30005 have the entries of the MAC address 76 and the IP/Prefix 77, whereby the frame matched with both conditions of the entries is transferred from the OLT to the ONU. The LLIDs 3004 and 3005 are judged to be used because the entry in which the MAC address 76 and the IP/Prefix 77 are stored is present (the number of entry is 1 or greater), whereas the LLID 3127 is judged to be unused because the number of entry is 0.

In the PPP mode, the MAC address 76 and the session ID 78 are registered as the entry in the database or erased from the database, based on the snoop result of the PPPoE sequence. In FIG. 7, there is described an example in which the LLID 3007 operates in the PPP mode. Herein, the LLID 3007 has an entry in which the MAC address 76 and the Session ID 78 are registered, whereby the frame matched with both conditions of this entry is transferred from the OLT to the ONU. The LLID 3007 is judged to be used because the entry is present.

In the VID mode, transferability is judged based on only the VID value of the OLT input frame. In this case, the MAC address 76 is not learned. Since it is necessary to perform a transparency process for all the frames matched with the VID, the unused link determination 79 corresponding to the LLID in the VID mode always represents used. For example, the number of entry may be always set to 1. In FIG. 7, there is described an example in which the LLID 3006 is set in the VID mode.

In this database, the number of entry 75 of the LLIDs 3002, 3003 and 3127 is 0, and the state of the unused link determination 79 represents unused. When the user usage state management part 49 makes a unused link determination based on information in the transfer database 44a, these three LLIDs are determined as unused.

Next, the configuration of the statistical counter 44b referred by the user usage state management part 49 and the used/unused determination with the statistical counter 44b will be described below using FIG. 8. The statistical counter 44b may exist for each LLID, and the OLT may manage plural LLID counters.

FIG. 8 is an example of the statistical counter in the OLT in the case where the number of LLIDs is 128.

The statistical counter includes the LLID 81, an uplink counter previous acquisition value 82, an uplink counter current acquisition value 83, an increase 84 from the previous acquisition value to the current acquisition value, and unused link determination information 85.

The statistical counter acquires the number of transfer octets on each LLID at a predetermined time interval (e.g., a constant interval), and holds two values of the current acquisition value and the previous acquisition value. The user usage state management part 49 compares the current acquisition value and the previous acquisition value, and if the increase therebetween is zero (or smaller than a predetermined increase amount), determines to be unused. In FIG. 8, the LLIDs 3003 and 3006 are judged to be unused. Other than acquiring the number of octets, the appropriate data amount may be employed.

FIG. 4 is a state transition diagram of the user usage state management part.

After registration, the ONU 2 is placed in a used state S42. Thereafter, if there is no increase of the counter, or each entry is cleared, it transits to a determination protection state S41. In an example of this determination protection, a protection time of 300 seconds is provided, and if there is no change in the counter or the entry state within this time period in this state, the state is determined as the user unused S43. The other appropriate protection time may be set beforehand. If the counter is increased or the entry is added to the transfer database during the determination protection time, it transits to used state. The transition from the unused state to the used state occurs if Queue>0 (uplink data is present) with REPORT of the ONU. Any one or both of the used/unused determination with the transfer database and the used/unused determination with the statistical counter may be employed.

FIG. 9 is a flowchart showing a unused link detection counting process for the transfer database 44a in the user usage state management part 49. If the LLID transits to the determination protection state, the user usage state management part 49 (same below) firstly sets the timer to 300 seconds, for example, at S91, and makes the entry confirmation S92 for the object LLID. For example, by referring to the number of entry 75 of the transfer database 44a, the user usage state management part 49 determines that if the number of entry 75 is 1 or greater, the entry is present, and if it is 0, there is no entry. If the entry is present at S93, the LLID is determined to be used at S94, and this flow is ended. If there is no entry at S93, the user usage state management part 49 decrements the timer value at S95, and waits for one second at S96. If the timer value is 0 or greater at S97, the user usage state management part 49 returns to the entry confirmation S92, whereby the entry confirmation is repeated at a period of one second. When the timer reaches 0 at S97, the unused determination S98 is made. If the entry present is confirmed halfway, it is determined to be used, whereby the operation gets out of this flow.

FIG. 10 is a flowchart showing an unused link detection counting process of the statistical counter 44b in the user usage state management part 49. Transiting to a determination protection state, the user usage state management part 49 (same below) firstly sets the timer to 300 seconds, for example, at S101, and reads the counter for the object LLID at S102. The user usage state management part 49 compares the counter value with the previous value thereof at S103, and if there is increase at S104, the user usage state management part 49 determines that the LLID is used at S105, and sets the timer to 300 seconds again at S101. If there is no increase at S104, the user usage state management part 49 decrements the timer at S106, and waits for one second at S107. If the timer value is 0 or greater at S108, the user usage state management part 49 returns to the counter read S102 to read the counter at a period of one second, whereas if there is no increase, the user usage state management part 49 decrements the counter. When the timer reaches 0, the user usage state management part 49 determines that the LLID is unused. If the counter increase is confirmed halfway, it is determined to be used, whereby the operation gets out of this flow.

### Second Embodiment

Referring to FIGS. 2 and 3, the operation of a second embodiment of the invention will be described below.

A PON control part 42 on the OLT 4 acquires the information of the ONU 2 from the ONU 2 with a function of the OAM processing part 42c, using an OAM frame. The user usage state management part 49 acquires the information of the transfer database 22a and the statistical counter 22b on the ONU 2 via the OAM processing part 42c, instead of determining the user usage state based on the information of the transfer database 44a and the statistical counter 44b for the OLT 4, and determines the usagestate of the ONU 2 based on the acquired information. The transfer database 22a, 22b of the ONU 2 stores at least the entry of LLID used by the own ONU among the entries as shown in FIGS. 7 and 8. An L2/L3 entry determination flow of the user usage state management part 49 is shown in FIG. 9, and the entry information of the ONU 2 is used in the entry confirmation at S92. The flowchart of the entry confirmation S92 therein is shown in FIG. 13. The user usage state management part 49 makes an instruction of reading the ONU transfer database to the OAM processing part 42c, and the OAM processing part 42c reads the transfer database from the ONU 2, using the OAMPDU.

Also, a statistical counter determination flow of the user usage state management part 49 is shown in FIG. 10, and the counter of the ONU 2 is used in the counter read at S102. The flowchart of the counter read S102 therein is shown in FIG. 13. The user usage state management part 49 makes an instruction of reading the ONU statistical information to the OAM processing part 42c, and the OAM processing part 42c reads the statistical information from the ONU using the OAMPDU. The other configuration is the same as the first embodiment.

### Third Embodiment

Referring to FIG. 11, a third embodiment of the invention will be described below. In this embodiment, the transition condition from the unused state to the used state is modified in the state transition of the user usage state management part 49. Instead of the DBA Report in FIG. 4, the information of the increase in the statistical counter and the L2/L3 entry present is employed. In this case, there is an advantage that the same condition can be employed for the used/unused determination, but it is inferior to the method of FIG. 4 in that it may take more return time to the use state. Particularly, the generation of L3 entry requires the time by completion of the sequence between the terminal and the server. The other configuration is the same as the first embodiment.

### Fourth Embodiment

FIG. 12 is a sequence chart showing a forth embodiment of the invention. A difference from FIG. 6 is that if the user usage state management part 49 determines that the concerned LLID is unused at 61, the user usage state management part 49 instructs a mode change 62 to the DBA processing part 42b and the OAM processing part 42c for setting in a power saving mode 63, whereby the DBA processing part changes the polling cycle of the DBA control part 42b, and the OAM processing part 42c makes a cycle change notification 121 to the ONU 2, using the OAM frame. According to the cycle change notification, the ONU 2 can recognize the next POLL_GATE receiving timing, and the ONU 2 transits itself to the sleeve mode for a certain time, so that the function blocks of the ONU control part 22, except for the O/E conversion part 23 of FIG. 3 and the reception buffer, can be stopped within a polling cycle time, thereby increasing the power saving effect. The other configuration is the same as the first embodiment.

### Other Embodiments

A PON system according to this embodiment has a station side apparatus and plural home side apparatuses, for example, which are connected via an optical fiber network having an optical splitter, in which the station side apparatus includes a DBA processing part for controlling the frame transfer in the direction from ONU to OLT, a transfer database part for managing the destination of user frame transfer from the OLT to plural ONUs, a statistical counter part for counting the transfer data amount of each user, and a user usage state management part for managing the user usage situation.

The user usage state management part determines the user usage situation based on the state monitoring result of one or all of the DBA processing part, the transfer database part and the statistical counter part, switches the operation of the DBA control part depending on the use situation and adjusts the control frame amount between OLT and ONU.

In this embodiment, the user is determined to be in the quite state based on the presence or absence of user traffic to reduce the DBA control frame amount for use in the user frame transfer between ONU and OLT when not in use, whereby it is possible to reduce the operation frequency of the electronic circuits and the optical devices for both of the OLT and ONU and reduce the power consumption even in a state where the user can employ the network, such as when various kinds of terminal is being connected to the ONU and the power of the terminal is on.

The invention is applicable to the PON system, for example.

What is claimed is:

1. A passive optical network system comprising a station side apparatus and a plurality of home side apparatuses, in which the station side apparatus allocates uplink bandwidth to each of home side apparatuses by transmitting and receiving a control packets via logical links between the station side apparatus and each of home side apparatuses and provides allocated uplink bandwidth to the home side apparatuses, wherein
the station side apparatus comprises:
a transfer database for storing transfer information for specifying a destination of frame transfer from the station side apparatus to the plurality of home side apparatuses for each logical link;
a transfer processing part for performing a transfer process of a frame;
a statistical counter for counting a transfer data amount for each logical link; and
a usage state management part for determining a logical link for which the transfer information is not registered in the transfer database and/or a logical link for which a count value of the statistical counter is not increased within a predetermined time as unused link, and decreasing a control packet amount per unit time to the logical link that is determined as the unused link.

2. The passive optical network system according to claim 1, wherein
the station side apparatus decreases the control packet amount per unit time by increasing a sending interval of the control packets.

3. The passive optical network system according to claim 1, wherein
the transfer database stores the transfer information including an entry to be registered or deleted by a process according to a predetermined protocol, associated with an identifier of the logical link, and
the usage state management part determines a logical link in which the entry of transfer information is not registered as the unused link by referring to the transfer database.

4. The passive optical network system according to claim 3, wherein
the entry of transfer information in the transfer database is deleted while the logical link is maintained if there is a lack of communication on the logical link for a certain time period, or by a predetermined cutting sequence.

5. The passive optical network system according to claim 3, wherein
the transfer database further stores transfer mode information indicating a protocol of frame transfer on the logical link, associated with the identifier of the logical link, and
the entry is registered or deleted by the process according to the protocol which corresponds to the transfer mode information.

6. The passive optical network system according to claim 1, wherein
the usage state management part, upon receiving a data amount notification of data from the home side apparatus to the station side apparatus from the home side apparatus via the logical link in which the control packet amount per unit time has been decreased, restores the control packet amount per unit time for the logical link.

7. The passive optical network system according to claim 1, wherein
the usage state management part restores the control packet amount per unit time for the logical link in which the control packet amount per unit time has been decreased, if the transfer information is registered again in the transfer database and/or the count value of the statistical counter is increased, for the logical link.

8. The passive optical network system according to claim 1, wherein
a control frame amount between the station side apparatus and the home side apparatus is capable of being adjusted at multiple stages depending on user usage situation.

9. The passive optical network system according to claim 1, wherein
the station side apparatus further comprises a monitor control processing part for monitoring and controlling the home side apparatuses, and
the monitor control processing part notifies at least one home side apparatus among the plurality of home side apparatuses of usage state information indicating that the logical link is in use or unusedbased on an instruction from the usage state management part.

10. The passive optical network system according to claim 9, wherein
the home side apparatus switches a part or all of own home side apparatus to a power saving state for a predetermined time depending on the usage state information notified with a monitor control frame from the station side apparatus.

11. A passive optical network system comprising a station side apparatus and a plurality of home side apparatuses, in which the station side apparatus allocates uplink bandwidth to each of home side apparatuses by transmitting and receiving a control packets via logical links between the station side apparatus and each of home side apparatuses and provides allocated uplink bandwidth to the home side apparatuses, wherein
at least one of the home side apparatuses comprises:
a transfer database for storing transfer information for specifying a destination of frame transfer from the home side apparatus to a user terminal for each logical link;
a transfer processing part for performing a transfer process of a frame; and
a statistical counter for counting a transfer data amount for each logical link, and
the station side apparatus comprises:
a monitor control processing part for acquiring the transfer information of the transfer database and a count value of the statistical counter in the home side apparatus; and
a usage state management part for determining a logical link for which the transfer information is not registered in the transfer database and/or a logical link for which the count value of the statistical counter is not increased within a predetermined time as unused link, and decreasing a control packet amount per unit time to the logical link that is determined as the unused link.

12. A station side apparatus in a passive optical network system which includes the station side apparatus and a plurality of home side apparatuses, in which the station side apparatus allocates uplink bandwidth to each of home side apparatuses by transmitting and receiving a control packets via logical links between the station side apparatus and each of home side apparatuses and provides allocated uplink bandwidth to the home side apparatuses, the station side apparatus comprising:
a transfer database for storing transfer information for specifying a destination of frame transfer from the station side apparatus to the plurality of home side apparatuses for each logical link;
a transfer processing part for performing a transfer process of a frame;
a statistical counter for counting a transfer data amount for each logical link; and
a usage state management part for determining a logical link for which the transfer information is not registered in the transfer database and/or a logical link for which a count value of the statistical counter is not increased within a predetermined time as unused link, and decreasing a control packet amount per unit time to the logical link that is determined as the unused link.

13. A power consumption control method for use in a passive optical network system which includes a station side apparatus and a plurality of home side apparatuses, in which the station side apparatus allocates uplink bandwidth to each of home side apparatuses by transmitting and receiving a control packets via logical links between the station side apparatus and each of home side apparatuses and provides allocated uplink bandwidth to the home side apparatuses, the method comprising steps of:
registering or deleting transfer information for specifying a destination of frame transfer from the station side apparatus to the plurality of home side apparatuses for each logical link in or from a transfer database by a process of a predetermined protocol in accordance with a transfer mode of the logical link;
counting a transfer data amount for each logical link; and
determining a logical link for which the transfer information is not registered in the transfer database and/or a logical link for which a count value of the statistical counter is not increased within a predetermined time as unused link, and decreasing a control packet amount per unit time to the logical link that is determined as the unused link.
